(19) United States
(12) Patent Application Publication
(10) Pub. No.: US 2020/0038145 A1
(43) Pub. Date: Feb. 6, 2020

(54) ORTHODONTIC BRACKET

(71) Applicant: Hiroshi YAMADA, Osaka (JP)

(72) Inventor: Hiroshi YAMADA, Osaka (JP)

(21) Appl. No.: 16/606,027

(22) PCT Filed: Apr. 3, 2018
(86) PCT No.: PCT/JP2018/014220

§ 371 Date: Oct. 17, 2019

(30) Foreign Application Priority Data
Apr. 20, 2017 (JP) 2017-084009

(51) Int. Cl. A61C 7/14; A61C 7/20; A61C 7/28

(52) U.S. Cl. CPC A61C 7/146; A61C 7/28; A61C 7/20

(57) ABSTRACT

The purpose of the present invention is to provide an orthodontic bracket on which a ligature member can be easily hooked, and is capable of preventing the ligature member from becoming detached and of reducing friction during movement of teeth. An orthodontic bracket (11) includes a plate-like base portion (12) disposed such that a back surface (15a) thereof opposes a tooth surface, a pair of projecting portions (21a, 21b) projecting in the thickness direction from a front surface (15b) side of the base portion (12) with a space between the projecting portions (21a, 21b) such that they form a groove-like slot (22) in which an arch wire (44) is accommodated, and a pair of wing portions (31a, 31b) projecting from the pair of projecting portions in outward directions. Hook grooves (36a, 36b) for inserting a ring (45) therein are formed between the back surfaces of the pair of wing portions and the upper surface of the base portion. Hooking portions (28a, 28b) in deep portions of the hook grooves are provided at positions separated upward from the arch wire that is accommodated in the slot.

### TECHNICAL FIELD

The present invention relates to an orthodontic bracket (hereinafter, also simply referred to as “bracket”) used for orthodontic correction.

### BACKGROUND ART

The multi-bracket method is known as a method for correcting a patient's dentition. In the multi-bracket method, first, orthodontic brackets are individually bonded and fixed with adhesive to the teeth of a patient. Then, an orthodontic arch wire is attached to the slot provided in each of the brackets fixed to the teeth, and by applying force to the teeth through the arch wire in a desired direction of movement, the teeth can be moved.

PTL 1 and PTL 2 disclose techniques related to orthodontic correction using an orthodontic bracket and an arch wire.

The brackets described in PTL 1 and PTL 2 each include a slot (holding groove) for holding the arch wire, and a pair of wing portions on which a loop-like ligature member is hooked. The conventional bracket has a structure where the ligature member is hooked on the wing portions from above the arch wire that has been inserted in the slot.

### CITATION LIST

### Patent Literature

[PTL 1] Japanese Unexamined Patent Application Publication No. H08-215216

[PTL 2] Japanese Unexamined Patent Application Publication No. 2008-73344

### SUMMARY OF THE INVENTION

### Problems to be Solved by the Invention

However, the conventional bracket described in PTL 1 has a structure in which the arch wire is pressed against the bottom surface side of the slot by the ligature member. For this reason, due to the pressing force applied by the ligature member to the arch wire, friction (contact friction) is generated between the arch wire and the slot bottom surface. Accordingly, the conventional bracket has an issue that when the bracket and teeth move due to the load received from the arch wire, the friction becomes resistance, and the bracket and teeth cannot move smoothly along the arch wire.

In addition, the conventional bracket described in PTL 2 has an auxiliary wing portion on which a ligature member is hooked so that the ligation pressure with respect to the arch wire can be adjusted. However, since it is necessary to hook the ligature member on the auxiliary wing portion after hooking the ligature member on the wing portion, in the conventional bracket, ligation treatment using the ligature member is extremely complicated. In addition, since the conventional bracket is provided with the auxiliary wing portion on the wing portion, the bracket itself has a complicated shape, and accordingly, the tip of the auxiliary wing portion may come in contact with the surface of the patient's oral cavity, the mucous membrane in the oral cavity (oral mucosa) may be damaged, and the oral mucosa may peel off or become inflamed. In addition, since the auxiliary wing portion has a projecting shape projecting from the wing portion, if the ligature member is simply hooked thereon, the ligature member may easily become detached due to the load received from food when the patient bites the food. In addition, it is necessary for the auxiliary wing portion to be rigid enough to withstand the load when the ligature member is hooked thereon. For this reason, if the auxiliary wing portion is formed having a size that can ensure such rigidity, the bracket itself has a large size. Furthermore, since the bracket has a complicated shape, the mold used for manufacturing the bracket becomes complicated, and in addition, the number of processing steps during manufacturing may increase, which is not preferable in terms of manufacturing cost.

It is an object of the present invention to provide an orthodontic bracket that includes a wing portion on which a ligature member can be easily hooked, and is capable of preventing the ligature member, once it has been hooked on, from becoming detached, and reducing friction that is generated when the teeth move along the arch wire.

### Solution to the Problems

An orthodontic bracket according to an aspect of the present invention is bonded to a tooth surface of a patient and used for correcting dentition of the patient. The orthodontic bracket includes a base portion disposed such that a back surface thereof opposes the tooth surface, a pair of projecting portions, and a pair of wing portions. The pair of projecting portions project in a thickness direction of the base portion from a front surface side of the base portion, with a space between the projecting portions such that they form a groove-like slot in which an orthodontic arch wire is accommodated. The pair of wing portions each project, from an end portion in the thickness direction of each of the projecting portions, in an outward direction that extends perpendicularly to a direction in which the slot extends and toward an opposite side of a side on which the slot is positioned, such that a hook groove on which an orthodontic ligature member is hooked is formed between each wing portion and the front surface of the base portion. A hooking portion on which the ligature member is hooked that is positioned in a deep portion of the hook groove is provided at a position separated in the thickness direction from the arch wire that is accommodated in the slot.

In the orthodontic bracket having such a configuration, the hooking portion is disposed at a position separated in the thickness direction from the arch wire accommodated in the slot. For this reason, even when the ligature member is hooked on the pair of wing portions from above the arch wire that has been inserted in the slot, the ligature member does not press against the arch wire. For this reason, friction (contact friction) is less likely to be generated between the arch wire and the bottom surface of the slot, and as a result, when the bracket and teeth move due to the load received from the arch wire, the bracket and teeth move smoothly along the arch wire without receiving resistance of the friction. In addition, since it is not necessary to provide a portion for hooking on the ligature member besides the pair of wing portions, the orthodontic bracket can be realized with a simple configuration. In addition, since there is no extra portion such as an auxiliary wing portion, ligation treatment using the ligature member may be easily performed.

When the ligature member is a ring member having a circular cross section, the hooking portion may be configured to have an arc surface formed in the deep portion of the hook groove. This allows for the ligature member to be securely hooked on the hooking portion.

The hook groove may extend toward the slot side from an opening formed between a projecting end portion of each of the pair of wing portions and the front surface of the base portion, and may be inclined toward the thickness direction. With this configuration, once the ligature member has been inserted in the hook groove and hooked on the wing portion, the ligature member is securely held in the hook groove, and the ligature member is prevented from becoming detached.

The hook groove is formed by a first inner surface that is formed on the wing portion side and linearly extends from the opening to the hooking portion, and a second inner surface that is formed on the base portion side and extends in a curved shape from the opening to the hooking portion. With this configuration, the hook groove widens in a shape spreading outward from the opening, and then gradually narrows in a tapered shape toward the hooking portion. This reduces contact resistance received from the first inner surface and the second inner surface when the ligature member is inserted from the opening in the hook groove, and as a result, it is possible to smoothly guide the ligature member toward the hooking portion.

In this case, for example, the second inner surface includes an inclined surface that linearly extends from the opening toward the slot and inclines toward the back surface side of the base portion, and a curved surface that is connected to the inclined surface, extends in a curved shape toward the hooking portion, and inclines toward the thickness direction. This allows for the ligature member to be smoothly guided to the hooking portion along the curved surface of the second inner surface.

In addition, a first outer surface extending from an upper edge of the slot to the projecting end portion of each of the pair of wing portions may be inclined such that the upper edge side is high and the projecting end portion side is low. Furthermore, a second outer surface extending on the front surface of the base portion from the opening to an outer end portion in the outward direction may be inclined such that the opening side is high and the outer end portion side is low. With this configuration, when the patient eats food, the food moves smoothly along the inclines from the tooth surface side to the end portion side of the base portion, and further toward the projecting portions. This makes it possible to reduce the possibility that bits of food remain around the base portion. In addition, due to the smooth movement of the food, it is possible to reduce the resistance felt when the patient bites the food, and to reduce the possibility of the food getting caught. Accordingly, with this configuration, it is possible to reduce generation of cavities, and to allow the patient correcting his/her dentition to eat food comfortably. In addition, the orthodontic bracket is less likely to come in contact with the oral mucosa of the patient, and it is possible to prevent damage to the oral mucosa.

In addition, is it preferable that the first outer surface curves toward the projecting end portion, and that the second outer surface curves toward the outer end portion. With this configuration, it is possible for food to move more smoothly, and to further reduce the resistance of when food is bitten.

In addition, in the direction extending perpendicularly to the direction in which the slot extends, a front surface in the thickness direction of the orthodontic bracket may be formed, by the first outer surface and the second outer surface, in a curved surface that is curved as a whole. In this case, it is preferable that, in a cross section obtained by cutting in the thickness direction, a curvature of an arc that configures the first outer surface and a curvature of an arc that configures the second outer surface are the same. With this configuration, it is possible for food to move more smoothly on the entire front surface of the orthodontic bracket.

In addition, a region of the front surface of the base portion extending, in the direction in which the slot extends, from a base end portion of each of the pair of projecting portions to an end portion of the base portion may be inclined such that the base end portion side is high and the end portion side is low. With this configuration, it is possible for food to move more smoothly also in the direction in which the slot extends.

### Advantageous Effects of the Invention

According to the present invention, it is possible to easily hook a ligature member on a wing portion, prevent the ligature member, once it has been hooked on, from becoming detached, and reduce friction that is generated in a bracket when teeth move along an arch wire.

### BRIEF DESCRIPTION OF THE DRAWINGS

FIG. 1 is a perspective diagram of an orthodontic bracket according to an embodiment of the present invention.

FIG. 2 is a side view diagram of the orthodontic bracket shown in FIG. 1.

FIG. 3 is a top view diagram of the orthodontic bracket shown in FIG. 1.

FIG. 4 is a front view diagram of the orthodontic bracket shown in FIG. 1.

FIG. 5 is a cross-sectional diagram of the orthodontic bracket shown in FIG. 1.

FIG. 6 is a diagram showing a state where the orthodontic bracket shown in FIG. 1 is attached to a tooth.

FIG. 7 is a diagram showing the positional relationship of a ligature member and an arch wire in the orthodontic bracket shown in FIG. 1.

### DESCRIPTION OF EMBODIMENT

The following describes an embodiment of the present invention with reference to the accompanying drawings for the understanding of the invention. It should be noted that the following embodiment is merely an example of a specific embodiment of the present invention, and the embodiment of the present invention can be changed as appropriate within the scope of the present invention.

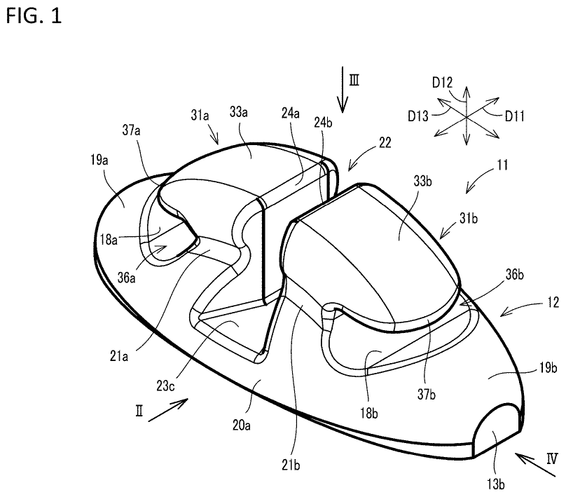

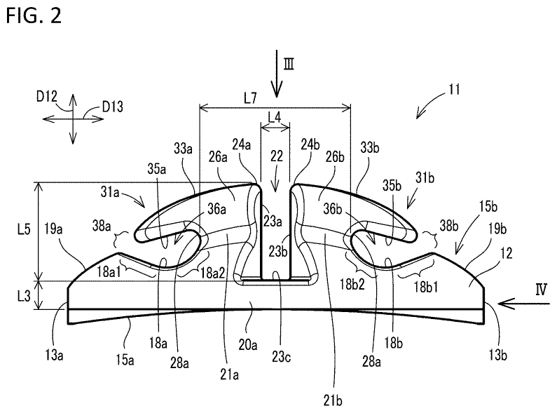

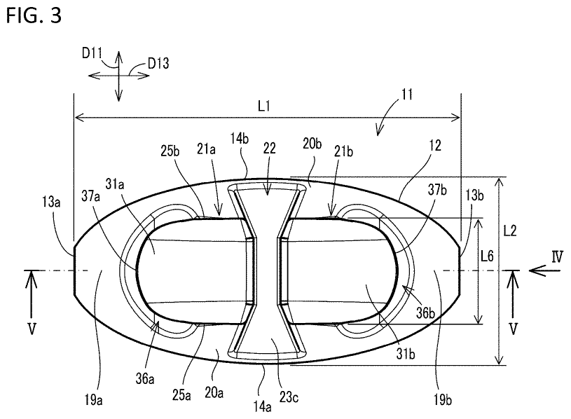

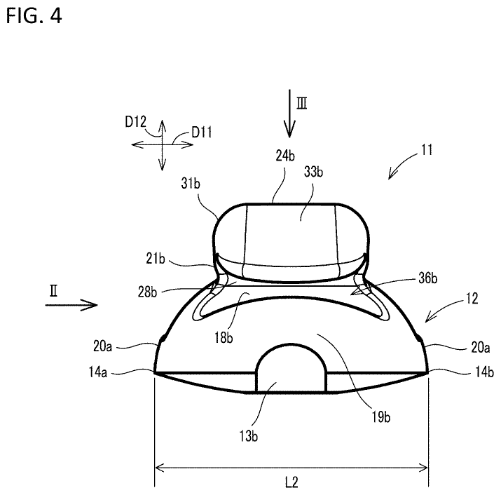

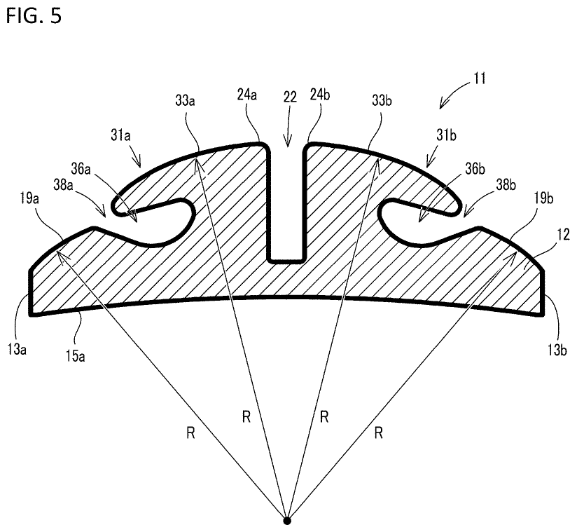

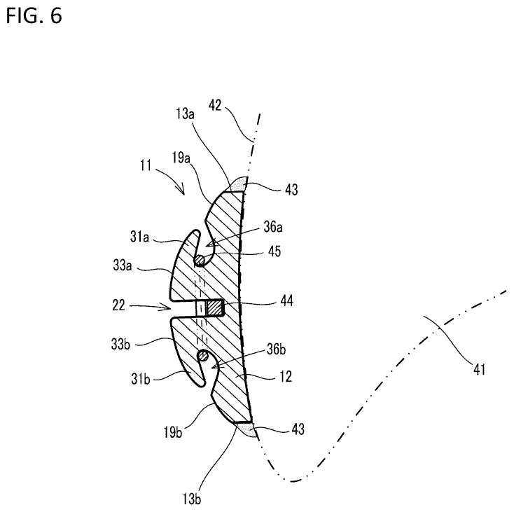

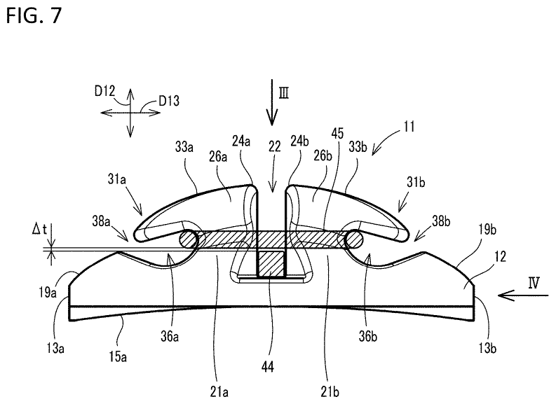

First, with reference to FIG. 1 to FIG. 6, a description is given of a configuration of an orthodontic bracket 11 (hereinafter abbreviated as a “bracket 11”) according to the embodiment of the present invention. Here, FIG. 1 is a perspective diagram of the bracket 11 according to the embodiment of the present invention. FIG. 2 is a side view diagram of the bracket 11 viewed from the side. FIG. 3 is a top view diagram of the bracket 11 viewed from above. FIG. 4 is a front view diagram of the bracket 11 viewed from the side. FIG. 5 is a cross-sectional diagram of the bracket 11. FIG. 6 is a diagram showing the bracket 11 in a state where it is attached to a tooth 41. FIG. 7 is a diagram showing the positional relationship of a ring 45 and an arch wire 44 in the bracket 11. In addition, FIG. 2 is equivalent to a diagram showing a view in the direction of an arrow II in FIG. 1, FIG. 3, and FIG. 4. FIG. 3 is equivalent to a diagram showing a view in the direction of an arrow III in FIG. 1, FIG. 2, and FIG. 4. FIG. 4 is equivalent to a diagram showing a view in the direction of an arrow IV in FIG. 1, FIG. 2, and FIG. 3. FIG. 5 shows the cross-sectional view taken along a line V-V in FIG. 3. It is noted that in order to facilitate understanding, in the following description, the direction indicated by the arrow II and its opposite direction are referred to as a horizontal direction, a width direction, or a short side direction (all are represented by reference sign D11), the direction indicated by the arrow III and its opposite direction are referred to as a height direction, an up-down direction, or a thickness direction (all are represented by reference sign D12), and the direction indicated by the arrow IV and its opposite direction are referred to as a vertical direction or a long side direction (both represented by reference sign D13). FIG. 5 is a vertical cross section passing through the center of the horizontal direction D11 of the bracket 11.

As shown in FIG. 6, the bracket 11 is bonded to a tooth surface 42 on the front side of the tooth 41 of a patient and is used for correcting the patient's dentition. The bracket 11 is directly or indirectly bonded and fixed to the tooth surface 42 via an adhesive 43. The bracket 11 is used along with the arch wire 44 for applying force to the tooth 41, and the ring 45 (an example of a ring member of the present invention) that is a ligature member (ligature wire) for holding the arch wire 44 on the bracket 11 so that it does not become detached from the bracket 11. Metal, ceramic, silicon, resin material, or the like is selected as the material for the bracket 11.

As shown in FIG. 1, the bracket 11 includes a base portion 12 that is substantially elliptical when viewed in the direction of the arrow III. Specifically, the base portion 12 has a long side in the vertical direction D13 and a short side in the horizontal direction D11. The base portion 12 has a shape in which both end portions in the long side direction D13 of the elliptical shape are cut off in a straight manner by a specific length in the height direction D12, and flat end surfaces 13a and 13b are provided at both end portions in the long side direction D13. In this case, both end portions in the long side direction D13 of the base portion 12 are respectively the end surfaces 13a and 13b. A length L1 in the long side direction D13 of the base portion 12, specifically, the length L1 (see FIG. 3) from the end surface 13a on one side to the end surface 13b on the other side is, for example, 5.8 mm. A length L2 in the short side direction D11 that is the width of the base portion 12, specifically, the length L2 from an end surface 14a one side in the short side direction D11 to an end surface 14b on the other side in the short side direction D11 is, for example, 2.8 mm.

As shown in FIG. 2 and FIG. 5, the base portion 12 has a slightly curved shape as a whole such that its central region is bulged and arched upward relative to its end portion regions. A back surface 15a on one side in the thickness direction D12 of the base portion 12 has an arc shape having a relatively small curvature when viewed from the horizontal direction D11. Specifically, the back surface 15a is an arc shape having a radius of, for example, 20 mm. The back surface 15a is the portion that is bonded, with the adhesive 43, to the tooth surface 42 of the patient's tooth 41, and is formed in a substantially flat shape. The curvature of the arc-shaped back surface 15a is appropriately selected according to the shape and bulge of the tooth surface 42 of the tooth 41 to which it is attached. In the present embodiment, the back surface 15a and the end surfaces 13a and 13b are configured to intersect at an angle slightly smaller than a right angle. It is noted that a front surface 15b on the other side in the thickness direction D12 of the base portion 12 is the surface that can be seen by a third party when the patient's mouth is opened.

As shown in FIG. 2 to FIG. 4, the bracket 11 includes a pair of columnal projecting portions 21a and 21b that project from the front surface 15b side of the base portion 12. The projecting portions 21a and 21b are provided integrally with the base portion 12. The pair of projecting portions 21a and 21b are provided extending straight in the thickness direction D12. The pair of projecting portions 21a and 21b are provided on the substantially elliptical base portion 12 juxtaposed in the long side direction D13 with a space between the projecting portions.

The pair of projecting portions 21a and 21b are provided on the base portion 12 with a space in the long side direction D13 therebetween such that they form a groove-like slot 22 (an example of a slot in the present invention) that accommodates the orthodontic arch wire 44 (see FIG. 6) described below. That is, the bracket 11 includes the slot 22. Specifically, the slot 22 is a space formed such that it is sandwiched by wall surfaces 23a and 23b that respectively oppose the pair of projecting portions 21a and 21b. The slot 22 has a shape extending in the horizontal direction D11. In the present embodiment, the slot 22 is formed in the center of the long side direction D13 in the bracket 11. In addition, the bracket 11 is formed in a symmetrical shape with respect to the long side direction D13 with the slot 22 as the boundary.

When the back surface 15a is on the lower side, the wall surfaces 23a and 23b extend vertically upward from the base portion 12. A bottom surface 23c of the slot 22 is a flat surface that extends in the horizontal direction D 11 and is perpendicular to the wall surfaces 23a and 23b. The arch wire 44 is disposed on the bottom surface 23c of the slot 22 (see FIG. 6). In the present embodiment, a metal wire having a square cross section and a side length of 0.41 mm is used as the arch wire 44. In addition, in the slot 22, a length L3 from the center portion of the back surface 15a to the bottom surface 23c is, for example, 0.4 mm. In addition, a length L4 of the width in the vertical direction D13 of the slot 22 is, in accordance with the outer diameter of the arch wire 44, for example, 0.41 mm. It is noted that the arch wire 44 is not limited to a square shape, and that of a round or rectangular shape may also be adopted.

When viewed in the horizontal direction D11, the pair of projecting portions 21a and 21b are provided such that the opposing wall surfaces 23a and 23b of the projecting portions 21a and 21b are parallel. In addition, when viewed in the horizontal direction D11, the highest positions in the pair of projecting portions 21a and 21b are, respectively, apex portions 24a and 24b that are equivalent to the upper edge portions of the slot 22. The apex portion 24a of the projecting portion 21a is the upper edge of the slot 22 and the upper end of the wall surface 23a. In addition, the apex portion 24b of the projecting portion 21b is the upper edge of the slot 22 and the upper end of the wall surface 23b.

The projecting portions 21a and 21b are provided extending in the horizontal direction D11. In addition, the slot 22 has a configuration where the so-called torque angle is 0°. A height L5 of the projecting portion 21a on one side, specifically, a length L5 from the bottom surface 23c to the apex portion 24a in the projecting direction of the projecting portion 21a (see FIG. 2) is, for example, 1.35 mm. The height of the projecting portion 21b on the other side is the same as the height L5 of the projecting portion 21a on the one side. That is, the height L5 of the pair of projecting portions 21a and 21b is the same as the groove depth from the bottom surface 23c of the slot 22 to the upper edge portion of the slot 22.

In addition, as shown in FIG. 3, a width L6 of the projecting portion 21a, specifically, a length L6 in the horizontal direction D11 from a wall surface 25a on one side to a wall surface 25b on the other side of the projecting portion 21a is, for example, 1.6 mm. The width of the projecting portion 21b on the other side is the same as the width L6 of the projecting portion 21a on the one side.

A pair of wing portions 31a and 31b are respectively provided on upper end portions 26a and 26b on the front surface 15b side of the pair of projecting portions 21a and 21b. The pair of wing portions 31a and 31b are portions on which the ring 45 that is the orthodontic ligature member is hooked (see FIG. 6). The wing portion 31a is provided integrally with the projecting portion 21a, and the wing portion 31b is provided integrally with the projecting portion 21b. That is, the pair of wing portions 31a and 31b are provided integrally with the base portion 12.

The wing portion 31a provided on the projecting portion 21a is provided projecting such that it extends from the upper end portion 26a of the projecting portion 21a toward the end surface 13a on one side of the base portion 12. The wing portion 31b provided on the projecting portion 21b is provided extending from the upper end portion 26b of the projecting portion 21b toward the end surface 13b on the other side of the base portion 12. That is, the bracket 11 has a configuration including the pair of wing portions 31a and 31b on which the ring 45 is hooked that respectively project, from the upper end portions 26a and 26b of the pair of projecting portions 21a and 21b, in outward directions (outer sides of the long side direction D13) that each extend perpendicularly to the direction in which the slot 22 extends and toward the opposite side of the side on which the slot 22 is positioned.

As shown in FIG. 1 and FIG. 2, a front surface 33a (an example of a first outer surface of the present invention) on the upper side of the projecting portion 21a and the wing portion 31a is an outer surface common to the projecting portion 21a and the wing portion 31a. The front surface 33a extends from the apex portion 24a that is the upper edge of the slot 22 to a projecting end portion 37a of the wing portion 31a. As shown in FIG. 2, the front surface 33a is inclined toward the outer side of the long side direction D13 such that the apex portion 24a is high and the projecting end portion 37a is low. Specifically, the front surface 33a is a curved surface that curves from the apex portion 24a to the projecting end portion 37a with a specific curvature. Similarly, a front surface 33b (an example of a first outer surface of the present invention) on the upper side of the projecting portion 21b and the wing portion 31b is an outer surface common to the projecting portion 21b and the wing portion 31b. The front surface 33b extends from the apex portion 24b that is the upper edge of the slot 22 to a projecting end portion 37b of the wing portion 31b. As shown in FIG. 2, the front surface 33b is inclined toward the outer side of the long side direction D13 such that the apex portion 24b is high and the projecting end portion 37b is low. Specifically, the front surface 33b is a curved surface that curves from the apex portion 24b to the projecting end portion 37b with the same curvature as the front surface 33a. That is, the bracket 11 has a configuration including the front surfaces 33a and 33b that respectively curve toward the projecting end portions 37a and 37b from the upper edge of the slot 22. It is noted that the projecting end portion 37a of the wing portion 31a positioned on the end surface 13a side of the base portion 12 is slightly curved in the horizontal direction D11 when viewed from above. In addition, the projecting end portion 37b is also slightly curved in the horizontal direction D 11 when viewed from above.

As shown in FIG. 1 and FIG. 2, in the present embodiment, the pair of wing portions 31a and 31b are provided on the bracket 11 such that hook grooves 36a and 36b (examples of a hook groove of the present invention) are respectively formed between the wing portions 31a and 31b and the front surface 15b of the base portion 12. That is, the bracket 11 includes the hook grooves 36a and 36b. The ring 45 (see FIG. 6) having a circular cross section that is the ligature member is inserted in the hook grooves 36a and 36b.

The hook groove 36a is a groove-like space formed by a back surface 35a (an example of a first inner surface of the present invention) of the wing portion 31a, and a front surface 18a (an example of a second inner surface of the present invention) of the base portion 12 on the side closer to the projecting portion 21a. It is noted that the front surface 18a is a part of the front surface 15b, and opposes the back surface 35a of the wing portion 31a. The hook groove 36a extends toward the slot 22 side from an opening 38a that is formed between the projecting end portion 37a of the wing portion 31a and the front surface 15b of the base portion 12. In addition, the hook groove 36a is formed in a shape that inclines obliquely upwards toward the slot 22 side from the opening 38a.

In addition, the hook groove 36b is formed in a shape symmetrical to the hook groove 36a with respect to the long side direction D13. That is, the hook groove 36b is a groove-like space formed by a back surface 35b (an example of a first inner surface of the present invention) of the wing portion 31b and a front surface 18b (an example of a second inner surface of the present invention) of the base portion 12 on the side closer to the projecting portion 21b. It is noted that the front surface 18b is a part of the front surface 15b, and opposes the back surface 35b of the wing portion 31b. The hook groove 36b extends toward the slot 22 side from an opening 38b that is formed between the projecting end portion 37b of the wing portion 31b and the front surface 15b of the base portion 12. In addition, the hook groove 36b is formed in a shape that inclines obliquely upwards toward the slot 22 side from the opening 38b. The hook grooves 36a and 36b are shaped extending in the horizontal direction D11.

The openings 38a and 38b are portions that respectively serve as entrances for when the ring 45 is inserted in the hook grooves 36a and 36b. The width of each of the openings 38a and 38b is formed such that the ring 45 can be inserted therein. For example, when a ligature wire described below is used as the ring 45, the width of each of the openings 38a and 38b is formed having a diameter that is slightly larger than that of the ligature wire. In addition, when an orthodontic rubber band described below is used as the ring 45, the width of each of the openings 38a and 38b is formed such that the orthodontic rubber band, in a state during ligation where it is stretched and its outer diameter is temporarily reduced, can be inserted therein. In the present embodiment, the width of each of the openings 38a and 38b is, for example, 0.234 mm.

The ring 45 is inserted in the hook grooves 36a and 36b and disposed in the deep portions thereof. Specifically, a hooking portion 28a is provided in the deep portion of the hook groove 36a. The latching portion 28a has an arc-shaped arc surface when viewed in the horizontal direction D11. Similarly, a hooking portion 28b is provided in the deep portion of the hook groove 36b. The hooking portion 28b has an arc-shaped arc surface when viewed in the horizontal direction D11. The hooking portion 28a is formed on the outer side surface in the long side direction D13 of the projecting portion 21a, and the hooking portion 28b is formed on the outer side surface in the long side direction D13 of the projecting portion 21b. A length L7 (see FIG. 2) in the long side direction D13 from the arc surface of the hooking portion 28a to the arc surface of the hooking portion 28b is, for example, 2.1 mm.

The ring 45 is attached such that it is hooked on the pair of wing portions 31a and 31b, by being inserted in the hook grooves 36a and 36b in a state where the arch wire 44 has been inserted in the slot 22. The ring 45 is, for example, a ligature wire made of metal wire or an orthodontic rubber band (also referred to as a module) made of an elastic material such as NBR or silicon rubber. In the case where the ring 45 is the ligature wire, at the time of ligation of the ligature wire, the ligature wire is inserted in the hook grooves 36a and 36b after being hooked on the pair of wing portions 31a and 31b. Then, the ligature wire is guided inside the hook grooves 36a and 36b along the inclines thereof by being pulled by tying pliers or the like. This allows for the ligature wire to be disposed in and hooked on the hooking portions 28a and 28b. In addition, in the case where the ring 45 is the orthodontic rubber band, when the orthodontic rubber band is stretched and hooked on the pair of wing portions 31a and 31b, the orthodontic rubber band is guided inside the hook grooves 36a and 36b along the inclines thereof by the restoring force of the elastic member trying to return to its original state. This allows for the orthodontic rubber band to be disposed in and hooked on the hooking portions 28a and 28b.

The ring 45 used in the present embodiment has a diameter of 0.2 mm to 0.3 mm. Specifically, as the ring 45, ligature wire having a diameter of 0.2 mm or an orthodontic rubber band having a diameter of 0.3 mm is used. In this case, each of the arc surfaces of the hooking portions 28a and 28b is formed having a radius that is the same as that of the ring 45 or slightly larger than that of the ring 45. Specifically, each of the arc surfaces of the hooking portions 28a and 28b is formed in an arc shape having a radius of 0.15 mm.

In the hook groove 36a, the back surface 35a of the wing portion 31a is a flat surface extending substantially linearly in an obliquely upward direction from the opening 38a to the hooking portion 28a. On the other hand, the front surface 18a of the base portion 12 has a curved surface that curves in a downward arc shape in a region between the opening 38a and the hooking portion 28a. Specifically, the front surface 18a is divided into an inclined surface 18a1 on the opening 38a side and a curved surface 18a2 on the deep side of the hook groove 36a. The inclined surface 18a1 is a substantially linear flat surface inclined obliquely downward (toward the back surface 15a side of the base portion 12) extending from the opening 38a toward the slot 22. On the other hand, the curved surface 18a2 is a surface that is continuous with the inclined surface 18a1 and extends in a curved shape that inclines upward (in the thickness direction D12) toward the hooking portion 28a. The curved surface 18a2 has, for example, an arc shape having a radius of 0.5 mm. It is noted that the boundary portion between the inclined surface 18a1 and the curved surface 18a2 is connected smoothly thereto.

Similarly to the hook groove 36a, in the hook groove 36b, the back surface 35b of the wing portion 31b is a flat surface extending substantially linearly in an obliquely upward direction from the opening 38b to the hooking portion 28b. The front surface 18b of the base portion 12 has a curved surface that curves in a downward arc shape in a region between the opening 38b and the hooking portion 28b. Specifically, the front surface 18b is divided into an inclined surface 18b1 on the opening 38b side and a curved surface 18b2 on the deep side of the hook groove 36b. The inclined surface 18b1 is a substantially linear flat surface inclined obliquely downward (toward the back surface 15a side of the base portion 12) extending from the opening 38b toward the slot 22. On the other hand, the curved surface 18b2 is a surface that is continuous with the inclined surface 18b1 and extends in a curved shape that inclines upward (in the thickness direction D12) toward the hooking portion 28b. The curved surface 18b2 has, for example, an arc shape having a radius of 0.5 mm. It is noted that the boundary portion between the inclined surface 18b1 and the curved surface 18b2 is connected smoothly thereto.

It is noted that the front surface 18a, the arc surface of the hooking portion 28a, and the back surface 35a are provided such that they are smoothly connected to one another. Similarly, the front surface 18b, the arc surface of the hooking portion 28b, and the back surface 35b are also provide such that they are smoothly connected. In addition, other portions common to the front surface 15b also have a configuration where they are smoothly connected.

In the present embodiment, as shown in FIG. 7, the hooking portion 28a is provided at a position separated upward in the thickness direction D12 from the arch wire 44 accommodated in the bottom surface 23c of the slot 22. In addition, the hooking portion 28b is also provided at a position separated upward in the thickness direction D12 from the arch wire 44 accommodated in the bottom surface 23c. Specifically, the hooking portions 28a and 28b are provided at positions such that space for a minute gap Δt is formed between the upper end surface of the arch wire 44 accommodated in the slot 22 and the bottom side surface of the ring 45 disposed in the hooking portions 28a and 28b. In the present embodiment, when an orthodontic rubber band having a diameter of 0.3 mm is used as the ring 45, the positions of the hooking portions 28a and 28b are determined so that the gap Δt is 0.04 mm.

In this way, the hooking portions 28a and 28b are disposed at positions separated in the thickness direction D12 from the arch wire 44 accommodated in the slot 22. Accordingly, even when the pair of wing portions 31a and 31b are hooked from above the arch wire 44 that has been inserted in the slot 22, and the ring 45 is disposed in the hooking portions 28a and 28b of the hook grooves 36a and 36b, the ring 45 does not press against the arch wire 44. Accordingly, friction (contact friction) due to the pressing force of the ring 45 is less likely to be generated between the arch wire 44 and the bottom surface 23c of the slot 22. As a result, when the bracket 11 and the tooth 41 move due to the load received from the arch wire 44, the bracket 11 and the tooth 41 smoothly move in the direction along the arch wire 44 without receiving resistance of the friction. In addition, since it is not necessary to provide a portion for hooking on the ring 45 besides the pair of wing portions 31a and 31b, it is possible to realize the bracket 11 with a simple configuration. In addition, since there is no extra portion such as an auxiliary wing portion included in a conventional bracket, ligation treatment using the ring 45 can be easily performed.

In addition, the hook grooves 36a and 36b extend from the openings 38a and 38b toward the slot 22 side and are each formed in a groove-like shape that inclines upward in the thickness direction D12. Accordingly, once the ring 45 is hooked on the hook grooves 36a and 36b, the ring 45 is automatically moved to the deep portions of the hook grooves 36a and 36b due to tension generated in the ring 45, and is disposed in the hooking portions 28a and 28b. With this configuration, since the ring 45 is held in the deep portions of the hook grooves 36a and 36b, the ring 45 is prevented from becoming detached from the hook grooves 36a and 36b. In particular, since the hook grooves 36a and 36b are respectively provided with the inclined surfaces 18a1 and 18b1 inclined obliquely downward, it is possible for the ring 45 to be easily inserted in the hook grooves 36a and 36b from the openings 38a and 38b during ligation. Furthermore, the hook grooves 36a and 36b are respectively provided with the curved surfaces 18a2 and 18b2 that are curved inclined surfaces inclined obliquely upward toward the hooking portions 28a and 28b. Accordingly, the ring 45 inserted in the hook grooves 36a and 36b is guided smoothly to the hooking portions 28a and 28b along the curved surfaces 18a2 and 18b2 by tension generated in the ring 45.

As shown in FIG. 2, on the front surface 15b of the base portion 12, inclined surfaces 19a and 19b (examples of a second outer surface of the present invention) are respectively provided on portions respectively extending from the openings 38a and 38b to the end surfaces 13a and 13b (examples of an outer end portion of the present invention) positioned on the outer sides in the long side direction D13. The inclined surface 19a extending from the opening 38a to the end surface 13a is inclined obliquely downward such that the opening 38a side is high and the end surface 13a side is low. Specifically, the inclined surface 19a is curved obliquely downward toward the end surface 13a. Similarly, the inclined surface 19b extending from the opening 38b to the end surface 13b is inclined obliquely downward such that the opening 38b side is high and the end surface 13b side is low. Specifically, the inclined surface 19b is curved obliquely downward toward the end surface 13b.

In the present embodiment, as shown in FIG. 5, in the cross section obtained by cutting the bracket 11 in the thickness direction D12, the curvature of the arcs configuring the front surfaces 33a and 33b and the curvature of the arcs configuring the inclined surfaces 19a and 19b are configured to be the same. Specifically, as shown in FIG. 5, the front surface 33a, the front surface 33b, the inclined surface 19a, and the inclined surface 19b are each formed in a curved shape such that they coincide with the same arc of a radius R.

In addition, as shown in FIG. 4, in the horizontal direction D11 in which the slot 22 extends, inclined surfaces 20a and 20b are respectively provided in the regions respectively extending from base end portions 39a and 39b of the pair of projecting portions 21a and 21b to the end surfaces 14a and 14b on the sides in horizontal direction D11 of the base portion 12. The inclined surfaces 20a and 20b are inclined such that the base end portions 39a and 39b sides are high and the end surfaces 14a and 14b sides are low, and specifically, are curved obliquely downward toward the end surfaces 14a and 14b.

Since the bracket 11 is configured as described above, when the bracket 11 is bonded to the tooth surface 42 of a patient and the orthodontic appliances such as the arch wire 44 are attached to the bracket 11, food that is chewed when the patient eats moves smoothly along the inclines of the inclined surfaces 19a and 19b from the tooth surface 42 side to the end surfaces 13a and 13b sides of the base portion 12, and further toward the projecting portions 21a and 21b sides. In this way, the possibility of bits of food remaining around the bracket 11 is greatly reduced. It is noted that as shown in FIG. 6, the bracket 11 is bonded to the tooth surface 42 such that the adhesive 43 protrudes to the end surfaces 13a and 13b sides of the base portion 12. For this reason, the possibility of bits of food remaining on the outer sides of the end surfaces 13a and 13b is further reduced.

In addition, since the front surface 15b of the base portion 12 of the bracket 11 includes the inclined surfaces 19a and 19b, it is difficult for the bracket 11 to come in contact with the oral mucosa of the patient. In addition, since the inclined surface 19a, the front surface 33a, the front surface 33b, and the inclined surface 19b that configure the outer side surface of the upper side of the bracket 11 are curved surfaces that curve as a whole, it is difficult for the oral mucosa of the patient to be damaged even if the bracket 11 comes in contact thereto, and it is possible to prevent damage to the oral mucosa. In addition, due to the shape that is curved as a whole, it is possible for the patient to bite with little resistance when eating food. That is, due to the smooth movement of the food, it is possible to reduce the resistance felt when biting the food, and to reduce the possibility of the food getting caught. Accordingly, with the bracket 11 configured in this way, it is possible to reduce generation of cavities, and to allow the patient correcting his/her dentition to eat food comfortably.

In addition, the curvatures of the arcs that configure the front surface 33a, the front surface 33b, the inclined surface 19a, and the inclined surface 19b are the same. For this reason, it is possible for food to move more smoothly from the front surfaces 33a and 33b to the tooth surface 42 via the inclined surfaces 19a and 19b, and to reduce the resistance of when food is bitten.

In addition, in this case, since the base portion 12 is substantially elliptical, food also moves more smoothly on the side of the base portion 12. Accordingly, it is possible to reduce generation of cavities, and to allow the patient correcting his/her dentition to eat food more comfortably.

It is noted that in the embodiment described above, the slot 22 provided in the bracket 11 has a configuration where the so-called torque angle is 0°, but the present invention is not limited to this and may have a configuration where the slot 22 is provided with a torque angle of a number of degrees.

In addition, in the embodiment described above, the back surface 15a of the base portion 12 of the bracket 11 is configured to have an arc shape, but the present invention is not limited to this configuration, and the back surface 15a of the base portion 12 may be a flat surface.

In addition, in the embodiment described above, the inclined surfaces 19a and 19b and the inclined surfaces 20a and 20b are curved surfaces that curve outward, but the present invention is not limited to this configuration, and the inclined surfaces may be configured by tapered inclined surfaces, that is, flat surfaces.

In addition, in the present embodiment, the base portion 12 is configured to be substantially elliptical, but the present invention is not limited to this configuration, and for example, the base portion 12 may be configured to have, when viewed in the thickness direction D12, a polygonal shape such as a rectangular shape or a square shape, or may have another shape.

In addition, in the present embodiment, the bracket 11 is bonded to the front surface side of the tooth 41, but the present invention is not limited to this configuration, and the present invention may be applied to a case where bracket 11 is bonded to the back side of the tooth 41.

1. An orthodontic bracket that is bonded to a tooth surface of a patient and used for correcting dentition of the patient, comprising:
a base portion disposed such that a back surface of the base portion opposes the tooth surface;
a pair of projecting portions configured to project in a thickness direction of the base portion from a front surface side of the base portion, with a space between the projecting portions such that the projecting portions form a groove-like slot in which an orthodontic arch wire is accommodated; and
a pair of wing portions each configured to project, from an end portion in the thickness direction of each of the projecting portions, in an outward direction that extends perpendicularly to a direction in which the slot extends and toward an opposite side of a side on which the slot is positioned, such that a hook groove on which an orthodontic ligature member is hooked is formed between each wing portion and the front surface of the base portion, wherein
a hooking portion on which the ligature member is hooked that is positioned in a deep portion of the hook groove is provided at a position separated in the thickness direction from the arch wire that is accommodated in the slot,
the hook groove extends toward the slot side from an opening formed between a projecting end portion of each of the pair of wing portions and the front surface of the base portion, and includes a second inner surface having a downward curved shape that is formed in a region, in a surface on the base portion side, extending from the opening to the hooking portion, and
the second inner surface is positioned higher than a bottom surface of the slot.

2. The orthodontic bracket according to claim 1, wherein
the ligature member is a ring member having a circular cross section, and
the hooking portion includes an arc surface formed in the deep portion of the hook groove.

3. The orthodontic bracket according to claim 1, wherein the hook groove inclines toward the thickness direction.

4. The orthodontic bracket according to claim 1, wherein the hook groove includes a first inner surface that is formed on the wing portion side and linearly extends from the opening to the hooking portion.

5. The orthodontic bracket according to claim 1, wherein
the second inner surface includes
an inclined surface that linearly extends from the opening toward the slot side and inclines toward the back surface side of the base portion, and
a curved surface that is connected to the inclined surface, extends in a curved shape toward the hooking portion, and inclines toward the thickness direction.

6. The orthodontic bracket according to claim 3, wherein
a first outer surface extending from an upper edge of the slot to the projecting end portion of each of the pair of wing portions is inclined such that the upper edge side is high and the projecting end portion side is low, and
a second outer surface extending on the front surface of the base portion from the opening to an outer end portion in the outward direction is inclined such that the opening side is high and the outer end portion side is low.

7. The orthodontic bracket according to claim 6, wherein
the first outer surface is curved toward the projecting end portion, and the second outer surface is curved toward the outer end portion.

8. The orthodontic bracket according to claim 7, wherein
in the direction extending perpendicularly to the direction in which the slot extends, a front surface in the thickness direction of the orthodontic bracket is formed, by the first outer surface and the second outer surface, in a curved surface that is curved as a whole.

9. The orthodontic bracket according to claim 8, wherein
in a cross section obtained by cutting in the thickness direction, a curvature of an arc that configures the first outer surface and a curvature of an arc that configures the second outer surface are the same.

10. The orthodontic bracket according to claim 1, wherein
a region of the front surface of the base portion extending, in the direction in which the slot extends, from a base end portion of each of the pair of projecting portions to an end portion of the base portion is inclined such that the base end portion side is high and the end portion side is low.

11. The orthodontic bracket according to claim 1, wherein
the base portion, when viewed in the thickness direction, has a substantially elliptical shape that is elongated in the direction perpendicular to the direction in which the slot extends.
